(19) United States
(12) Patent Application Publication
(10) Pub. No.: US 2016/0292306 A1
(43) Pub. Date: Oct. 6, 2016

(54) SIMULATOR CUSTOMIZATION TOOL AND METHOD FOR THE GENERATION AND MAINTENANCE OF SIMULATION CONFIGURATION

(71) Applicant: CAE INC., Saint-Laurent (CA)

(72) Inventors: Joel Migneault, St-Hubert (CA); Marc-Andre Proulx, Blainville (CA)

(21) Appl. No.: 14/672,322

(22) Filed: Mar. 30, 2015

(51) Int. Cl. G06F 17/50

(52) U.S. Cl. CPC G06F 17/50

(57) ABSTRACT

A customizable tool and method for generating, validating and maintaining simulation artefacts. A template corresponding to a particular type of simulation artefacts is selected among a plurality of templates. A library of components corresponding to the selected template is determined by a processing unit of the tool. The library of components is displayed on a display of the tool. At least one component is selected among a library of components corresponding to the selected template. The at least one selected component is displayed on the display. The at least one selected component is configured. The processing unit generates and validates simulation artefacts corresponding to the selected template based on the at least one selected component and the configuration of each selected component.

### TECHNICAL FIELD

The present disclosure relates to the field of simulator design. More specifically, the present disclosure relates to a customizable tool and method for the generation and maintenance of simulation artefacts.

### BACKGROUND

Simulators are used to practice complex and potentially dangerous tasks in a realistic and secure environment. For instance, flight simulators are used by commercial airlines and air forces to train their pilots to face various types of situations. Practicing on a flight simulator is also usually less costly than practicing on a real aircraft.

A simulator is a very complex system generally including hardware, software, actuators, sensors, displays, switches, etc. A simulation software is executed by the simulator for controlling the execution of various simulation scenarios, each simulation scenario involving specific components of the simulator. For instance, the simulation software controls the interactions of particular components of a simulated vehicle and simulates particular functionalities of these components.

Various software tools are used for the design and maintenance of the simulator, each tool being dedicated to a particular aspect of the simulator. For instance, a first tool may be dedicated to the design and customization of Instructor Operating Station (IOS) pages, which allow an instructor to control in real time the execution of a particular simulation scenario. Another tool may be dedicated to the generation of vehicle models, which specify the components of a particular vehicle simulated by the simulator, and define the functionalities and interactions of these components. However, using various tools instead of a single tool can be challenging for consistency and maintenance purposes. It also adds to the complexity to perform standardized practices amongst different types of users involved in the design and maintenance of the simulator.

Therefore, there is a need for a customizable tool and method for the generation and maintenance of simulation artefacts.

### SUMMARY

According to a first aspect, the present disclosure provides a customizable tool for the generation and maintenance of simulation artefacts. The tool comprises a processing unit, memory, a display, and a user interface. The memory stores generated simulation artefacts. The user interface provides for selecting a template corresponding to a particular type of simulation artefacts among a plurality of templates. The user interface also provides for selecting at least one component among a library of components corresponding to the selected template. The user interface further provides for configuring the at least one selected component. The processing unit displays the plurality of templates on the display. The processing unit determines the library of components corresponding to the selected template. The processing unit displays the library of components on the display. The processing unit displays the at least one selected component on the display. The processing unit generates and validates the simulation artefacts corresponding to the selected template based on the at least one selected component and the configuration of each selected component. The communication interface provides for transmitting the validated simulation artefacts to a simulator.

According to a second aspect, the present disclosure provides a method for the generation and maintenance of simulation artefacts. The method comprises selecting a template corresponding to a particular type of simulation artefacts among a plurality of templates. The method comprises determining a library of components corresponding to the selected template. The method comprises displaying the library of components on a display. The method comprises selecting at least one component among the library of components. The method comprises displaying the at least one selected component on the display. The method comprises configuring the at least one selected component. The method comprises generating and validating, by a processing unit, simulation artefacts corresponding to the selected template based on the at least one selected component and the configuration of each selected component. The method comprises automatically validating, by the processing unit, the generated simulation artefacts upon detection of a change in the library of components.

According to a third aspect, the present disclosure provides a non-transitory computer program product comprising instructions deliverable via an electronically-readable media, such as storage media and communication links. The instructions comprised in the non-transitory computer program product, when executed by a processing unit, provide for generating, validating and maintaining simulation artefacts by implementing the aforementioned method.

### BRIEF DESCRIPTION OF THE DRAWINGS

Embodiments of the disclosure will be described by way of example only with reference to the accompanying drawings, in which:

FIG. 1 represents a customizable tool for the generation, validation and maintenance of simulation artefacts;

FIG. 2 represents a method for the generation, validation and maintenance of simulation artefacts; and

FIGS. 3, 4, 5A, 5B, 5C, 6A, 6B and 6C represent several Graphical User Interfaces implemented by the customizable tool of FIG. 1 for performing steps of the method of FIG. 2.

### DETAILED DESCRIPTION

The foregoing and other features will become more apparent upon reading of the following non-restrictive description of illustrative embodiments thereof, given by way of example only with reference to the accompanying drawings. Like numerals represent like features on the various drawings.

Various aspects of the present disclosure generally address one or more of the problems related to the integration of a plurality of functionalities allowing the design of a simulator into a single customizable design tool.

The following terminology is used throughout the present disclosure:
Simulation artefacts: the term artefact is generally used in the context of software development life cycle (SDLC), and refers to various items produced at various steps of the software development process. It can include for example data models, setup scripts, configuration files, documentation, test plans, etc. In the context of the present disclosure, simulation artefacts consist in various items for configuring a simulator to implement a particular functionality, controlling or monitoring the execution of a particular functionality, etc. Examples of simulation artefacts include a list of simulated components selected for implementing a specific functionality of the simulator, values for parameters of the simulated components, interconnections between the simulated components, computer programs for implementing the simulated components, Graphical User Interfaces (GUIs) for interacting with the simulated components, etc.

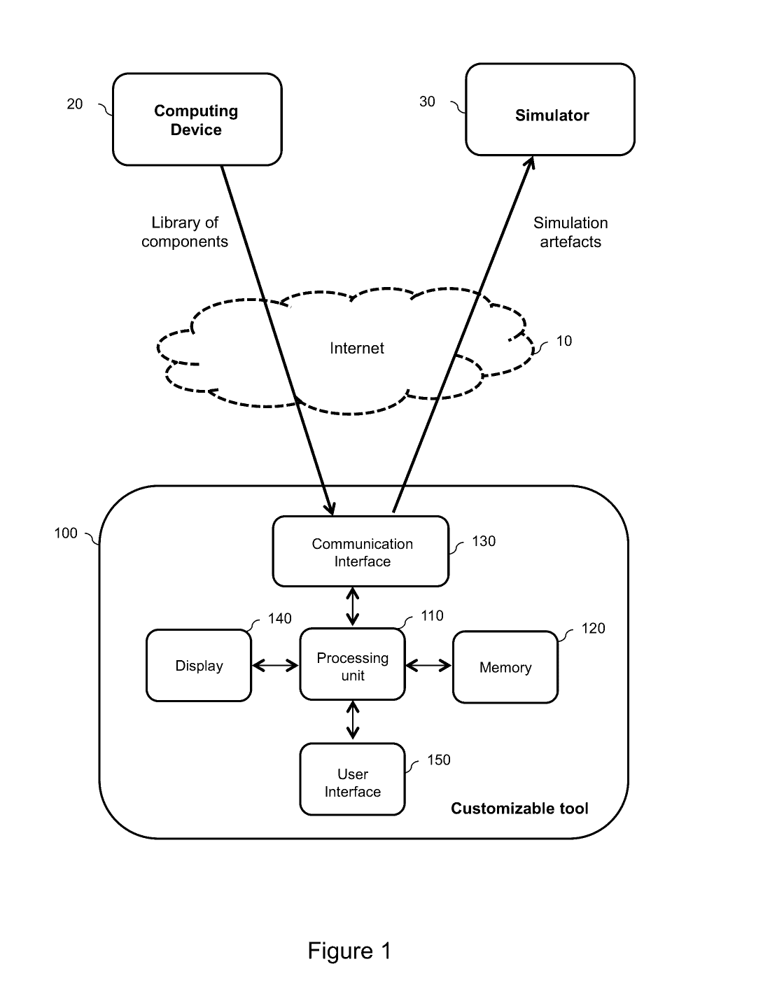

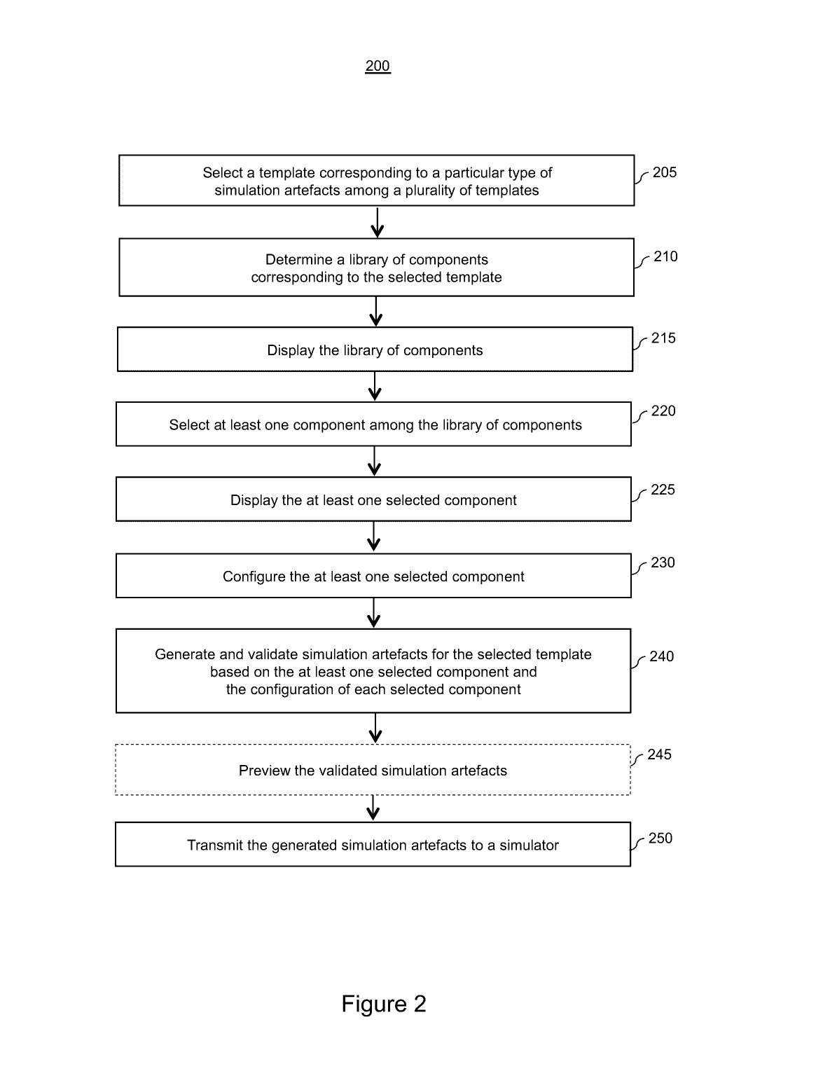

Referring now concurrently to FIGS. 1 and 2, a customizable tool 100 and a method 200 for the generation, validation and maintenance of simulation artefacts are presented. At least some of the steps of the method 200 are implemented by the customizable tool 100.

The customizable tool 100 comprises a processing unit 110, having one or more processors (not represented in FIG. 1 for simplification purposes) capable of executing instructions of computer program(s). Each processor may further have one or several cores. The customizable tool 100 also comprises memory 120 for storing instructions of the computer program(s), data generated by the execution of the computer program(s), data received via a communication interface 130, etc. Only a single memory 120 is represented in FIG. 1, but the customizable tool 100 may comprise several types of memories, including volatile memory (such as a volatile Random Access Memory (RAM)) and non-volatile memory (such as a hard drive).

The customizable tool 100 comprises the communication interface 130 (e.g. a Wi-Fi interface, an Ethernet interface, a combination thereof, etc.) for exchanging data with other entities over communication links generally referred to as the Internet 10 for simplification purposes. The other entities include one or more computing devices 20 which transmit data (e.g. a library of components) to the customizable tool 100, the transmitted data being processed by the processing unit 110. The other entities also include one or more simulators 30 which receive data (e.g. simulation artefacts) transmitted by the customizable tool 100, the transmitted data being generated by the processing unit 110. The Internet 10 may encompass a Local Area Network or Intranet, for exchanging data between the customizable tool 100 and entities located at the same premises. The Internet 10 may also encompass a Wide Area Network or Extranet, for exchanging data between the customizable tool 100 and entities located at remote premises. For example, the customizable tool 100 may be located at the premises of a manufacturer of simulators, while the simulator 30 may be located at the premises of a company having purchased the simulator 30 from the manufacturer.

The customizable tool 100 comprises a display 140 for displaying information generated by the processing unit 110, information stored in the memory 120, information received via the communication interface 130, etc. The customizable tool 100 also comprises a user interface 150 (e.g. a keyboard, a mouse, a trackpad, a touchscreen, a combination thereof, etc.) for receiving configuration data from a user of the customizable tool 100. The configuration data are generated by the interactions of the user, via the user interface 150, with the information displayed on the display 140.

Although not represented in FIG. 1 for simplification purposes, the computing device 20 and the simulator 30 comprise at least one communication interface for exchanging data with the customizable tool 100 over the Internet 10, and at least one processing unit for generating and/or processing the data exchanged with the customizable tool 100.

In the remainder of the description, reference is made to instructions of a specific computer program. The instructions of the specific computer program implement at least some of the steps of the method 200. The instructions are comprised in a non-transitory computer program product (e.g. memory 120), and provide for the generation and maintenance of simulation artefacts when executed by the processing unit 110. The instructions of the non-transitory computer program product are deliverable via an electronically-readable media, such as a storage media (e.g. a USB key, a CD-ROM, etc.) or communication links (e.g. the Internet 10 through the communication interface 130).

The method 200 represented in FIG. 2 comprises steps for generating, validating and maintaining simulation artefacts.

The method 200 comprises the step 205 of selecting a template corresponding to a particular type of simulation artefacts among a plurality of templates. The customizable tool 100 is capable of generating a plurality of types of simulation artefacts, and is customized in real time (based on the selected template) for accommodating the needs of a specific type of user currently using the customizable tool 100. For example, a system specialist is responsible for generating a particular type of simulation artefacts consisting in artefacts for simulation models. Simulation models are used for defining the execution of one or more functionalities of a simulator. In another example, a User Interface integrator is responsible for generating another particular type of simulation artefacts consisting in artefacts for simulation control pages. Simulation control pages are used by an instructor for controlling the execution of one or more functionalities of a simulator. Still another particular type of simulation artefacts consists in artefacts for simulation monitoring pages, which could be generated by either one of the system specialist or the User Interface integrator. Simulation monitoring pages are used for the maintenance, tuning or debug of a simulator. There is one particular template for generating artefacts for simulation models, another particular template for generating artefacts for simulation control pages, still another template for generating artefacts for simulation monitoring pages, etc. There is also another particular template for hardware interface and wiring diagrams, to be used by maintenance technicians to define or modify hardware interfaces and connections and wiring diagrams. The customizable tool 100 can support any number of templates, each template being used for generating a particular type of simulation artefacts. The templates can be stored in the memory 120.

Based on the specific type of user currently using the customizable tool 100, only a subset of the available templates may be selected for this user. For instance, the subset depends on specific access rights of the specific user, which can be determined based on user credentials when the specific user logs on the customizable tool 100. If the subset comprises several candidate types of templates, the processing unit 100 displays the candidate templates on the display 140 for selection by the user. The processing unit 110 selects one of the candidate templates, based on a corresponding selection by the user of one of the displayed candidate templates via the user interface 150. Alternatively, if the subset comprises a single template, the processing unit 110 automatically selects this single template. For instance, the first case corresponds to a user being allowed to generate artefacts for simulation control pages and artefacts for simulation monitoring pages; while the second case corresponds to a user being allowed to only generate artefacts for simulation models.

The templates supported by the customizable tool 100 may be configured by an administrator at the customizable tool 100. For instance, the administrator uses the user interface 150 for interacting with a dedicated Graphical User Interface (GUI) displayed on the display 140, to configure the supported templates. The configured templates are further stored in the memory 120. The configuration may comprise determining at least one of the following for each template: a name, a unique identifier, a description of the simulation artefacts which can be generated with the template, a representative icon, a particular GUI to be displayed on the display 140 upon selection at step 205, etc. The particular GUI is customized for allowing generation of particular simulation artefacts corresponding to the template. The configuration also comprises associating a library (or possibly several libraries) of components to the template. For instance, each library of components has a unique identifier, and the association consists in associating the unique identifier of the library with the template. Alternatively, the configuration of the templates supported by the customizable tool 100 is performed at a remote computing device 20, and transmitted to the customizable tool 100 over the Internet 10 via its communication interface 130, for further storage in the memory 120.

The access rights of the users with respect to the templates supported by the customizable tool 100 may also be configured by an administrator at the customizable tool 100. For instance, the administrator uses the user interface 150 for interacting with a dedicated Graphical User Interface (GUI) displayed on the display 140, to configure the access rights of the users. The configured access rights are further stored in the memory 120. Alternatively, the configuration of the access rights of the users is performed at a remote computing device 20, and transmitted to the customizable tool 100 over the Internet 10 via its communication interface 130, for further storage in the memory 120.

The method 200 comprises the step 210 of determining, by the processing unit 110, a library of components corresponding to the selected template. For example, several libraries of components may be permanently stored in the memory 120, and the processing unit 110 determines which among the several stored libraries correspond to the selected template. Alternatively, the library corresponding to the selected template is not available at the customizable tool 100, but is received from a computing device 20 via the Internet 10. For instance, the processing unit 110 determines the unique identifier of the library associated to the selected template, and transmits this unique identifier to the computing device 20 via the communication interface 130. In return, the computing device 20 transmits the library corresponding to the unique identifier to the processing unit 110 via the communication interface 130. The transmitted library can be temporarily or permanently stored in the memory 120. Libraries can be stored in a plurality of computing devices 20, in which case the selected template may also comprise an identification of the particular computing device 20 where the library corresponding to a particular unique identifier is stored.

The method 200 comprises the step 215 of displaying, by the processing unit 110, the library of components determined at step 210 on the display 140. The manner in which a particular library is displayed on the display 140 depends on the components of the library. For example, some libraries may be displayed via a generic GUI capable of supporting several different libraries, while other libraries may be displayed via respective customized GUIs.

In a particular aspect, the library of components determined at step 210 comprises a hierarchy of components and sub-components, and the display at step 215 of the library of components is representative of the hierarchy. For example, the template selected at step 205 is for generating simulation artefacts of a simulation model of a simulator, such as for example a vehicle simulator, a mining application simulator, a medical simulator, etc. The library of components comprises a hierarchy of systems, sub-systems, and parts representative for that particular simulator, which throughout the following examples will refer to a simulator for a particular aircraft. Examples of systems for an aircraft include the engines, the landing gear, etc. The engines comprise several sub-systems, such as a left engine and a right engine, which respectively comprise several parts. The landing gear also comprises several sub-systems, such as left wheels and right wheels, which respectively comprise several parts. The display of the hierarchy of components may consist in permanently displaying the various systems on the display 140. Then, upon selection of a particular system via the user interface 150, the corresponding sub-systems are displayed on the display 140. Similarly, upon selection of a particular sub-system via the user interface 150, the corresponding parts are displayed on the display 140. The sub-systems and parts are not permanently displayed on the display 150, but can be hidden through a pre-determined interaction with the user interface 150. For instance, a hierarchy of menus and sub-menus can be used for this purpose. Thus, a user can efficiently and ergonomically access any of the components of the hierarchy, for further selection of a component as per step 220 of the method 200.

In another particular aspect, a plurality of libraries of components corresponding to the selected template are determined at step 210, and the plurality of libraries of components are displayed on the display 140 at step 215. A component can be selected among the plurality of libraries of components, as per step 220 of the method 200. For example, the selected template is for generating simulation artefacts of simulation models of a plurality of types of aircrafts. Each library among the plurality of determined libraries comprises the hierarchy of components of a particular type of aircraft (e.g. system, sub-systems, and parts). In another example, the selected template is for generating simulation artefacts of simulation models of a particular type of aircraft. Each library among the plurality of determined libraries comprises the hierarchy of components of a particular system of the aircraft (e.g. sub-systems and parts). In still another example, one or more libraries among the plurality of determined libraries are generic and can be used for several templates; while one or more libraries among the plurality of determined libraries are specific and can be used only for the template selected at step 205.

In still another particular aspect, a user may select (via the user interface 150), at step 210, one or more additional libraries not included in the template selected at step 205. For instance, the one or more additional libraries offer specialized components not included in the one or more libraries included in the selected template. In this case, the processing unit 110 determines if the one or more additional libraries are compatible with the type of simulation artefacts which can be generated with the selected template. Furthermore, the processing unit 110 may also determine if the one or more additional libraries are compatible with the one or more libraries included in the selected template. In case of compatibility, the user may have the option to permanently add the one or more additional libraries to the selected template, so that in the future they are always considered when performing step 210 of the method 200. Thus, the customizable tool 100 combines an automated mode, where libraries are automatically added based on the selected template; and a manual mode, where libraries are added on demand by a user to fulfill a specific need.

As illustrated in the aforementioned aspects, the usage of templates and corresponding libraries of components offers a large flexibility and multiple customization capabilities to the tool 100. It can also provide an abstraction layer with respect to a library of components, which is for example generated at a Computer Aided Design (CAD) workstation 20 and used by the customizable tool 100. For instance, if the library generated by the CAD workstation 20 comprises a hierarchy of systems and sub-systems, a template selected at step 205 may define a library of components matching exactly the hierarchy of components generated by the CAD workstation 20. Alternatively, a template selected at step 205 may define a plurality of libraries of components, each library matching a particular system or sub-system of the hierarchy of components generated by the CAD workstation 20. In still another alternative, a template selected at step 205 may define a single library of components matching a particular system or sub-system of the hierarchy of components generated by the CAD workstation 20.

The method 200 comprises the step 220 of selecting, via the user interface 150, at least one component among the library of components displayed on the display 140. As mentioned previously, the library of components is generally displayed in a hierarchical manner, and the selection of a particular component is achieved by browsing through a hierarchy of graphical control elements (e.g. menus and sub-menus, list boxes, etc.).

The method 200 comprises the step 225 of displaying, by the processing unit 110, the at least one component selected at step 220 on the display 140. At step 215 of the method, a component of the library is generally represented in a schematic manner (e.g. an icon, an item in a list of selectable components, etc.). At step 225 of the method, a selected component is represented in a more detailed manner (e.g. an image or a diagram showing details of the selected component) for facilitating its configuration performed at step 230 of the method. The GUI of the customizable tool 100 further provides common features generally offered by design applications for manipulating the selected components(s) currently displayed on the display 140. Such features may include, without limitation: zoom, pan, arrange, align, bring to, group, etc.

The method 200 comprises the step 230 of configuring, via the user interface 150, the at least one component selected at step 220 and displayed at step 225. The configuration of a particular component may involve various interactions of the user with the GUI of the customizable tool 100 though the user interface 150. For example, by right clicking on a particular component, a hierarchy of overlaid menus and sub-menus is displayed with configuration options. In another example, a particular component is chosen by left clicking on this particular component, and various graphical control elements of the GUI of the customizable tool 100 dedicated to the configuration of the components can then be used.

The options available for the configuration of a particular component depend on specific characteristics of the particular component. For instance, in a particular aspect, a component comprises one or more parameters, which can be configured at step 230. The configuration of a parameter consists in allocating one or several values to the parameter. For example, a minimum value, a maximum value and a default value can be configured at step 230. The libraries of components may include a pre-defined range or set of acceptable values for some of the parameters of some of the components, and the processing unit 110 controls that for these parameters, only acceptable values are configured at step 230. Furthermore, one or more parameters of a component may have pre-defined values which cannot be configured at step 230.

In another particular aspect, a component comprises one or more interfaces, which can be configured at step 230. The configuration of an interface consists in connecting this interface with an interface of another component. For example, several components of a system can be displayed at step 225, and the one or more interfaces of each of these components are also represented on the display 225. The user can connect (via the user interface 150) an interface of a first component of the system with an interface of a second component of the system. The connection is represented by a link displayed on the display 225. In another example, the user can connect (via the user interface 150) an interface of a component of the system with an interface of a component of another system not currently displayed (not selected at step 220). In this second example, the user browses through a hierarchy of systems and components to identify the interface of the component of the other system. The connection may be represented by a link with an icon displayed on the display 140. The icon is representative of the component of the other system, and cannot be used to configure the component of the other system as per step 230. The libraries of components may include a pre-defined set of acceptable candidate interfaces for connection to some particular interfaces of some of the components selected as per step 220 and displayed as per step 225. The processing unit 110 controls that for these particular interfaces, only acceptable candidate interfaces are configured at step 230. The compatibility between two interfaces can depend on various characteristics of the respective interfaces, such as a type of data transmitted (e.g. a volume of fluid without restrictions on the type of fluid, a volume of a specific fluid such as kerosene), a range of values for the transmitted data (e.g. a volume no greater than one cubic meter per second), etc. Furthermore, one or more interfaces of a component may have pre-defined connections (which cannot be configured at step 230) with interfaces of other components.

The selection of an acceptable candidate interface for connection may be a complex and time consuming task for a user of the customizable tool 100. Thus, the tool 100 may automate the selection process as follows. First, the user selects (via the user interface 150) the interface to be configured among the one or more configurable interfaces of a component selected as per step 220 and displayed as per step 225. Then, the processing unit 110 automatically determines a list of corresponding interfaces of corresponding components. Each corresponding interface is compatible with the interface to be configured. The processing unit 110 displays the list of corresponding interfaces on the display 140 (e.g. in an overlaid selection list comprising the corresponding interfaces). Finally, the user selects (via the user interface 150) a corresponding interface from the list for connection with the interface being configured. The list of corresponding interfaces compatible with the interface being configured may be determined in real time by the processing unit 110, based on at least one characteristic of the interface to be configured (e.g. type of data transmitted, range of values for the transmitted data, etc.). Alternatively, the list is pre-configured and stored in the memory 120, in which case the processing unit 110 simply retrieves the appropriate list from the memory 120.

The method 200 comprises the step 240 of generating and validating, by the processing unit 110, simulation artefacts corresponding to the template selected at step 205 and components configured. The generation is based on the at least one component selected at step 220 and the configuration of each selected component at step 230.

In a particular aspect, the template selected at step 205 corresponds to artefacts for simulation models. The simulation artefacts comprise the components selected at step 220, which implement one or several functionalities of the simulator. The artefacts also comprise the configuration of the parameters of the components performed at step 230. The artefacts further comprise the configuration of the interfaces of the components performed at step 230 (interconnections between interfaces of some of the components selected at step 220 and/or interconnections of interfaces of some of the components selected at step 220 with interfaces of other components of the simulator not selected at step 220). The artefacts may also include simulation software for implementing the simulation functionalities supported by the component selected at step 220. Alternatively, the artefacts include a reference to the simulation software, which can be used by the simulator 30 for selecting from its memory/downloading via its communication interface the simulation software corresponding to the reference. The simulation software and/or reference to the simulation software are included in the libraries of components determined at step 210. An example of generation of this type of simulation artefacts via the GUI of the customizable tool 100 will be provided later in the description.

In another particular aspect, the template selected at step 205 corresponds to artefacts for simulation control pages or simulation monitoring pages. The simulation artefacts comprise the components selected at step 220, which consist in graphical control elements (e.g. menus, buttons, lists of selectable items, etc.) for interacting with one or several functionalities of the simulator. The artefacts also comprise the configuration of the parameters of the components performed at step 230. The artefacts further comprise the configuration of the interfaces of the components performed at step 230 (interconnections of interfaces of some of the components selected at step 220 with functionalities of the simulator through interfaces of components of the simulator). An example of generation of this type of simulation artefacts via the GUI of the customizable tool 100 will be provided later in the description.

The simulation artefacts may be generated according to a proprietary format. Alternatively, a standardized format, such as the Extensible Markup Language (XML), is used for the generation of the simulation artefacts. The artefacts generated and validated at step 240 are stored in one or more files, which can be stored in the memory 120. A file containing simulation artefacts may include a generic part (e.g. a header) common to all types of simulation artefacts, and a specific part adapted to the specific type of generated simulation artefacts (e.g. simulation models, simulation control or monitoring pages, etc.). For instance, the header can include a date of generation, an author, a revision history, a version number of the customizable tool 100, a version number for the libraries of components used, an identification of the target simulator(s) 30, etc.

Furthermore, validating performed in step 240 comprises automatically detecting by the processing unit 110 conflicts between generated simulation artefacts. The detection can be performed only between simulation artefacts being currently generated, as well as between simulation artefacts being currently generated and previously generated simulation artefacts permanently stored in the memory 120. For example, in the case of simulation artefacts corresponding to a simulation model, a first simulation component (e.g. a tank) has a parameter (e.g. pressure of kerosene) having a maximum and a minimum value, the value of the parameter being applicable to an element (e.g. kerosene) being outputted by an interface (e.g. a valve) of the first component. A second simulation component (e.g. an engine) has a parameter (e.g. pressure of kerosene) having a maximum and a minimum value, the value of the parameter being applicable to an element (e.g. kerosene) being inputted by an interface (e.g. a valve) of the second component. If the generated simulation artefacts define an interconnection between the respective interfaces of the first and second components (e.g. for transferring the kerosene from the tank to the engine), then the processing unit 110 automatically detects a conflict if the respective maximum and minimum values of the parameter (e.g. the pressure of the kerosene) for the first and second components are not compatible.

In another particular aspect, the step 230 of configuring a selected component consists in updating at least one characteristic of a component of a library of components, and the step 240 comprises automatically validating by the processing unit 110 currently generated and/or previously generated (stored in memory 120) simulation artefacts which depend on the at least one updated characteristic. The validation of step 240 includes automatically determining previously generated simulation artefacts permanently stored in the memory 120 which are impacted by the at least one updated characteristic. A user can be notified of the impacted simulation artefacts, and prompted to update the impacted simulation artefacts. Alternatively, for at least some of the impacted simulation artefacts, the simulation tool 100 is capable of automatically performing the necessary update to the impacted simulation artefacts, instead of prompting the user to perform the update manually.

The update of the at least one characteristic of the component may be received via the communication interface 130 from a computing device 20. Alternatively, the update can be performed directly by a user of the customizable tool 100 via the user interface 150, through a GUI displayed on the display 140 and dedicated to the update of components of libraries. One or several characteristics of one or several components of a library can be updated simultaneously. Examples of updated characteristics of a component of a library include one of the following: a configurable parameter and a configurable interface.

In still another particular aspect, step 245 comprises providing a preview mode for evaluating the generated and validated simulation artefacts in a standalone environment (e.g. sandbox execution and test).

The method 200 comprises the step 250 of transmitting, via the communication interface 130, the generated and validated simulation artefacts to the simulator 30 over the Internet 10. Although a single simulator 30 is represented in FIG. 1, the simulation artefacts can be transmitted to a plurality of simulators 30 (e.g. one or several simulators 30 currently under development or test/validation before delivery to a client, one or several simulators 30 operated by a plurality of clients at a plurality of client premises, etc.).

The simulation artefacts determine how the simulator 30 operates. For instance, in the case of a simulation model, the simulation artefacts define how specific simulated components interact (with each other, as well as with other simulated components) to implement one or several functionalities of the simulator via the execution of simulation software (by a processing unit of the simulator 30), taking into consideration operational parameters and conditions determined by the simulation artefacts. In the case of simulation control or monitoring pages, the simulation artefacts define how specific pages are generated (by a processing unit of the simulator 30) and presented to a user (via a display of the simulator 30), for allowing the user to interact with the simulator 30 (via a user interface of the simulator 30). The interactions consist in exchanging data with the simulator 30 through interfaces of components of the simulator 30, the exchanged data being received/transmitted by the control or monitoring pages. For example, an instructor can control the execution of a specific simulation functionality via a set of dedicated instructor control pages, while a trainee can practice the specific simulation functionality via a set of dedicated trainee control pages. Similarly, a tester/integrator can monitor the execution of a specific simulation functionality for validation purposes via a set of dedicated monitoring pages.

Generated and validated simulation artefacts corresponding to simulation models of several systems or sub-systems of the simulator 30 can be used simultaneously, to control the implementation and interactions of various functionalities of the simulator 30 corresponding to the several systems or sub-systems. For example, generated and validated simulation artefacts for respectively controlling the simulation of the cockpit, the engines and the landing gear of an aircraft can be used simultaneously by the processing unit of the simulator 30. In particular, the generated and validated simulation artefacts define the interactions between components of the cockpit, engines and landing gear through interfaces of these components.

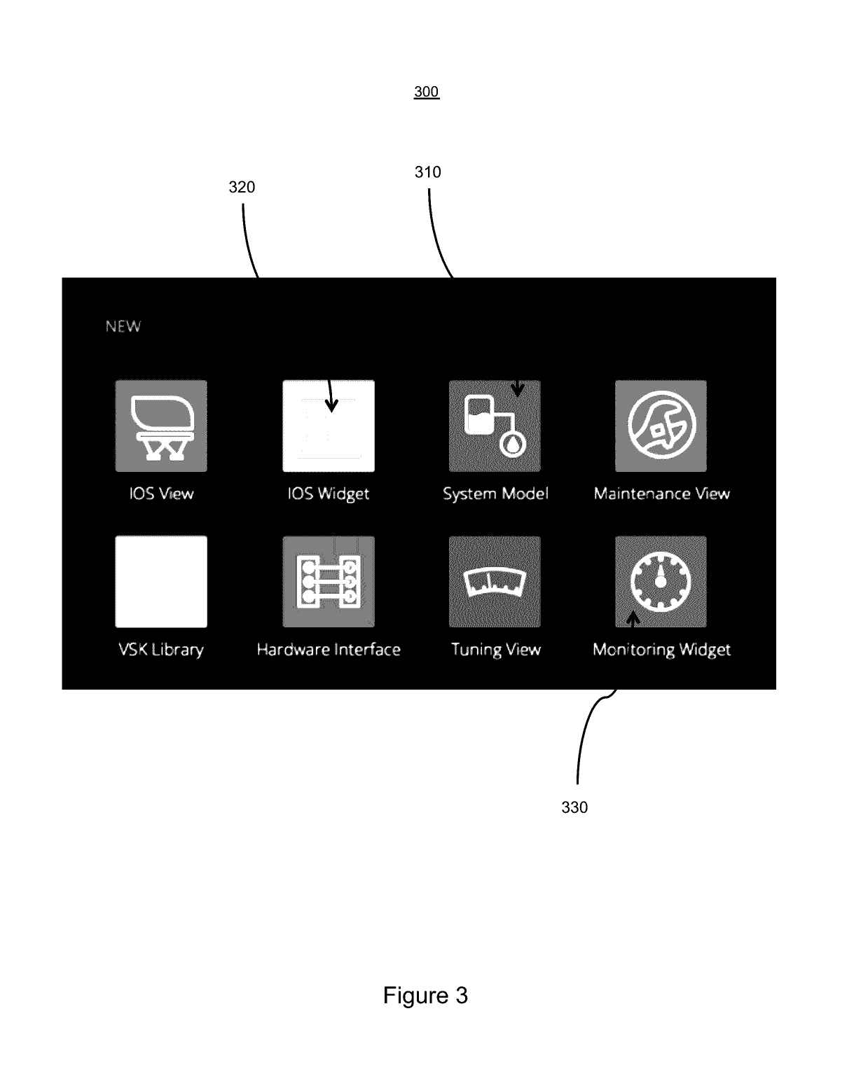

With reference to FIGS. 3, 4, 5A, 5B, 5C, 6A, 6B and 6C, several GUIs implemented by the customizable tool 100 for performing steps of the method 200 will now be illustrated.

Referring concurrently to FIGS. 2 and 3, a GUI 300 for selecting a template as per step 205 of the method 200 is represented. The GUI 300 comprises several templates selectable by a user, including a template 310 corresponding to artefacts for a simulation model, a template 320 corresponding to artefacts for simulation control pages, and a template 330 corresponding to artefacts for simulation monitoring pages. Upon selection of a specific template, the GUI 300 may allow the user to either create a new project for generating simulation artefacts corresponding to the selected template, or select one among a list of previously created projects for updating previously generated and validated simulation artefacts corresponding to the selected template.

Referring concurrently to FIGS. 2, 4, 5A, 5B and 5C, a GUI 400 for selecting, displaying and configuring components of a library of components as per steps 220, 225 and 230 of the method 200 is represented.

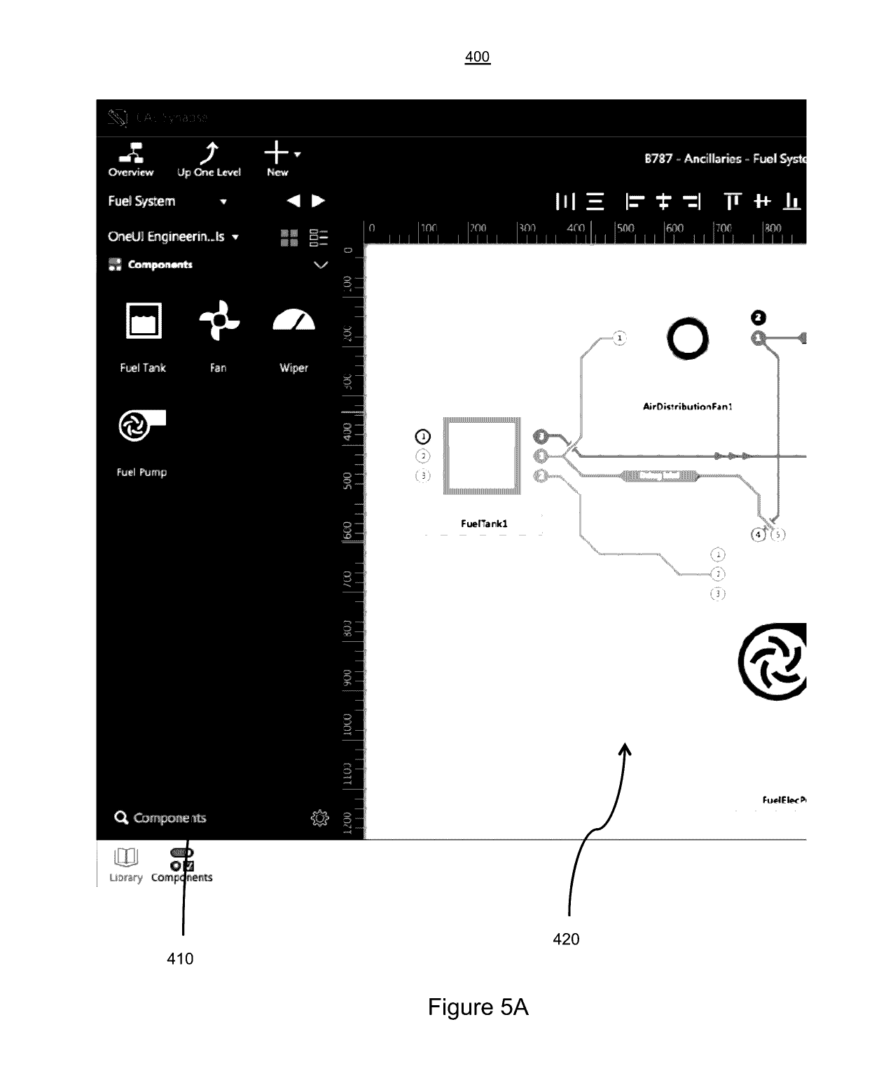

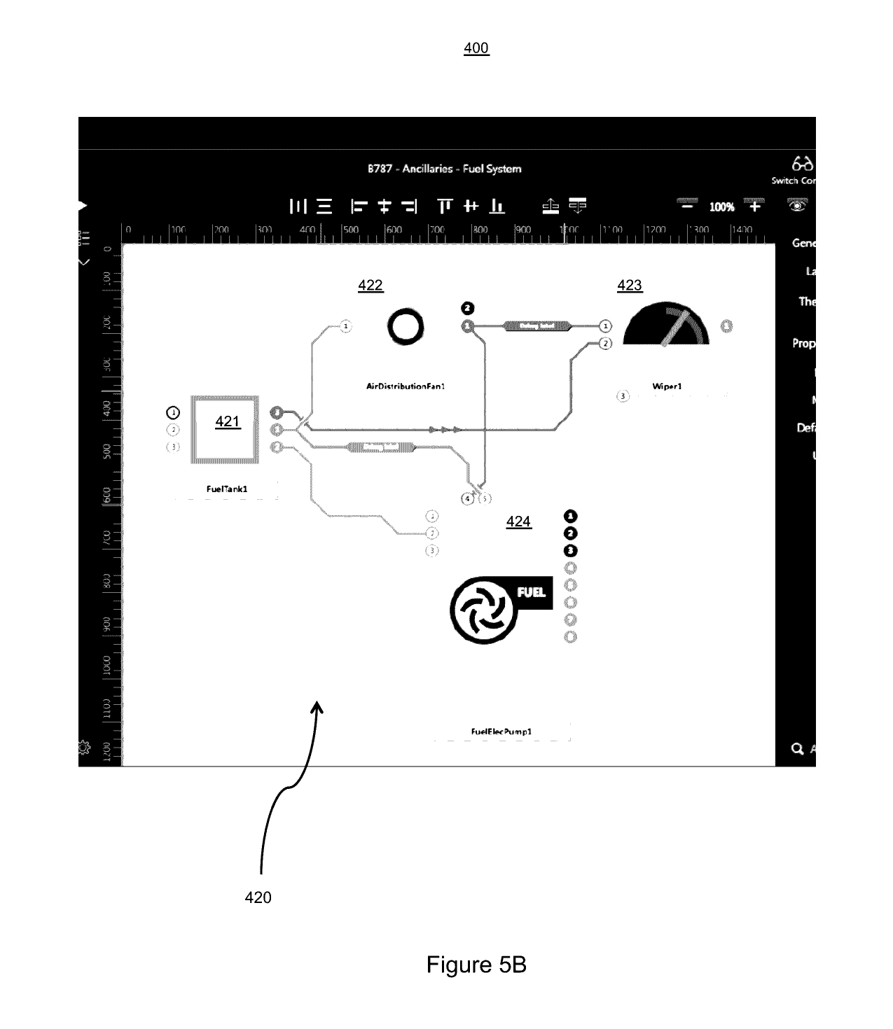

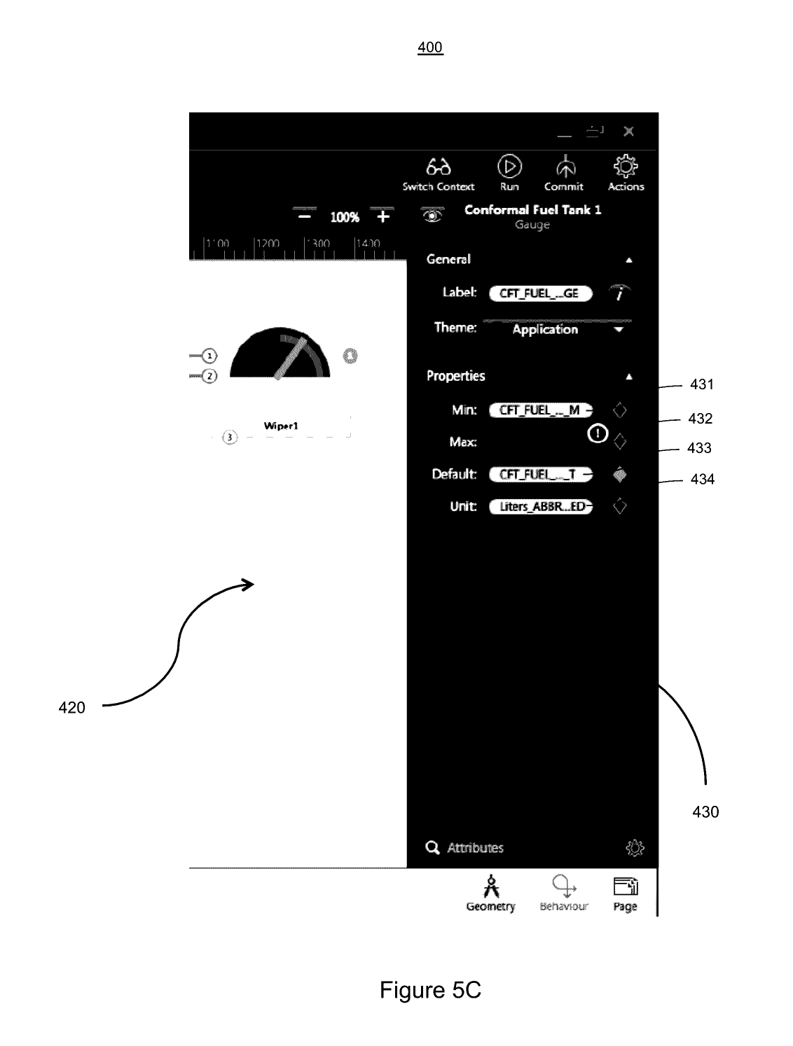

FIG. 5A represents a detailed view of a section 410 of the GUI 400 dedicated to the display of a library of components as per step 215 of the method 200, and to the selection of components among this library as per step 220 of the method 200. The library displayed (e.g. systems and sub-systems of an aircraft) has been determined as per step 210 of the method 200, based on the selection via the GUI 300 represented in FIG. 3 of a particular template (e.g. system model 310). For illustration purposes only, the displayed library consists of the hierarchy of systems and sub-systems of the aircraft, the GUI 400 allowing a user to browse through the different levels of the hierarchy. The currently displayed level of the hierarchy consists of a fuel system, comprising the following components which can be selected by a user: fuel tank, fan, wiper and fuel pump.

FIG. 5B represents a detailed view of a section 420 of the GUI 400 dedicated to the display of the selected components as per step 225 of the method 200. For illustration purposes, the four components represented in section 410 in FIG. 5A have been selected and are thus displayed in section 420 in FIG. 5B: the fuel tank 421, the fan 422, the wiper 423 and the fuel pump 424. Furthermore, interconnections between interfaces of the displayed components are also displayed in section 420. For example, a first interface of the fan 422 is connected to an interface of the fuel tank 421, a second interface of the fan 422 is connected to an interface of the wiper 423, and a third interface of the fan 422 is connected to an interface of the fuel pump 424. The interconnections between the selected components have been configured as per step 230 of the method 200, via interactions with the GUI 400 not represented in the Figures.

FIG. 5C represents a detailed view of a section 430 of the GUI 400 dedicated to the configuration of parameters of the selected components as per step 230 of the method 200. For illustration purposes, the configured parameter is a quantity of fuel in the fuel tank 421 represented in FIG. 5B. The following properties of the quantity of fuel can be configured via the GUI 400: a minimum value 431, a maximum value 432, a default value 433 and a unit 433 (e.g. liters)

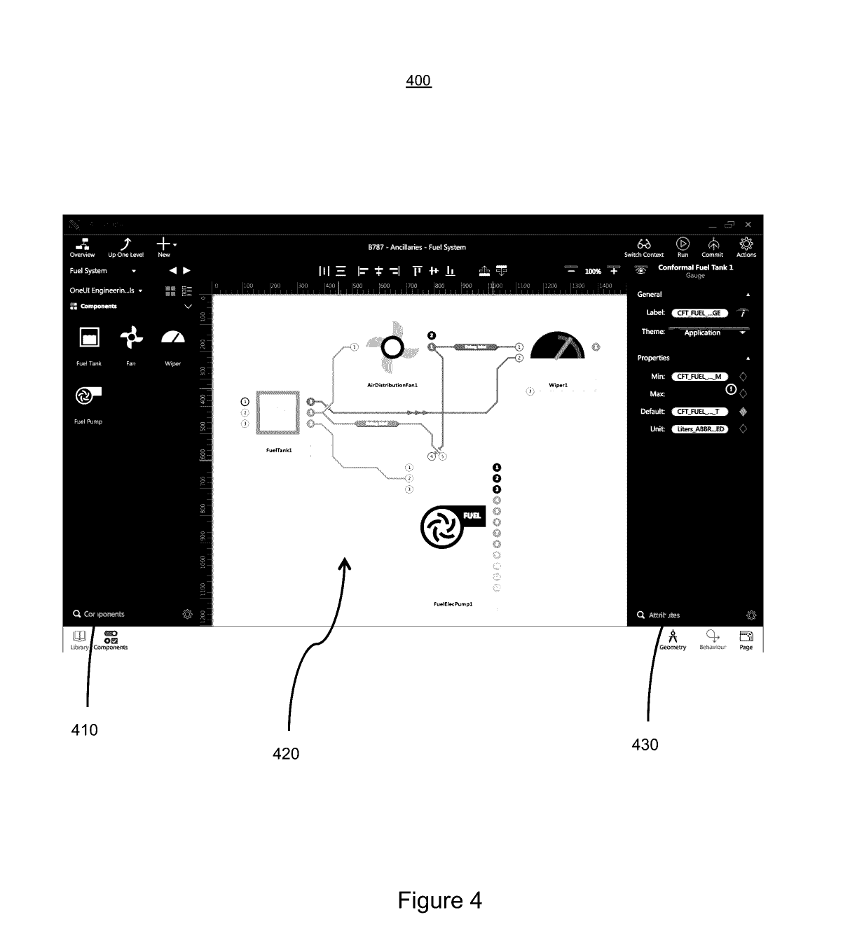

Reference is now made concurrently to FIGS. 2, 4, 6A, 6B and 6C, which illustrate an alternative configuration of the GUI 400 represented in FIG. 4, in the case where the particular template selected via the GUI 300 represented in FIG. 3 corresponds to artefacts for creating simulation control pages 320 or simulation monitoring pages 330.

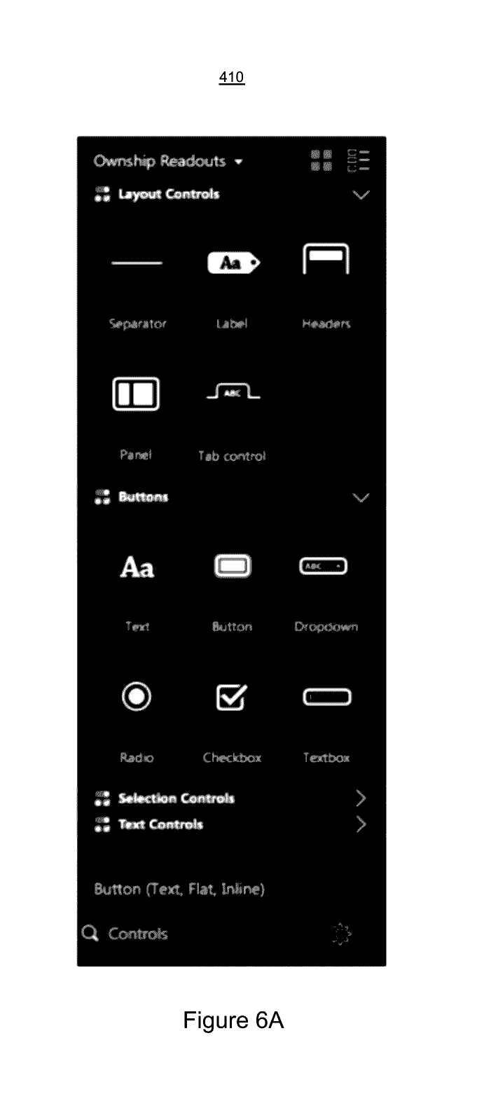

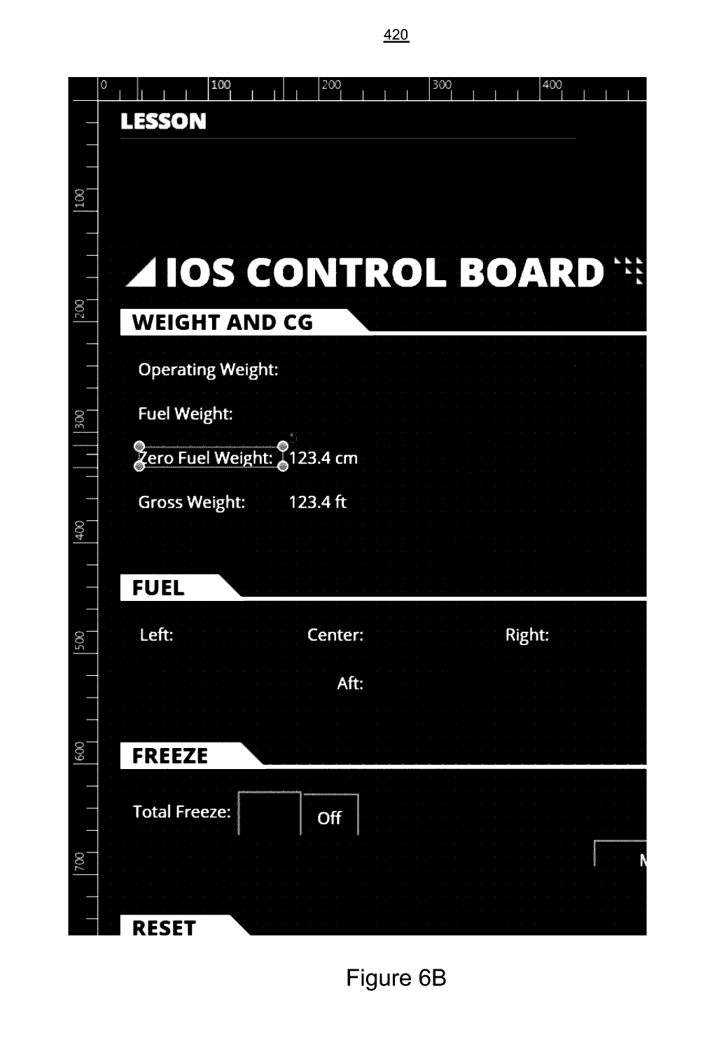

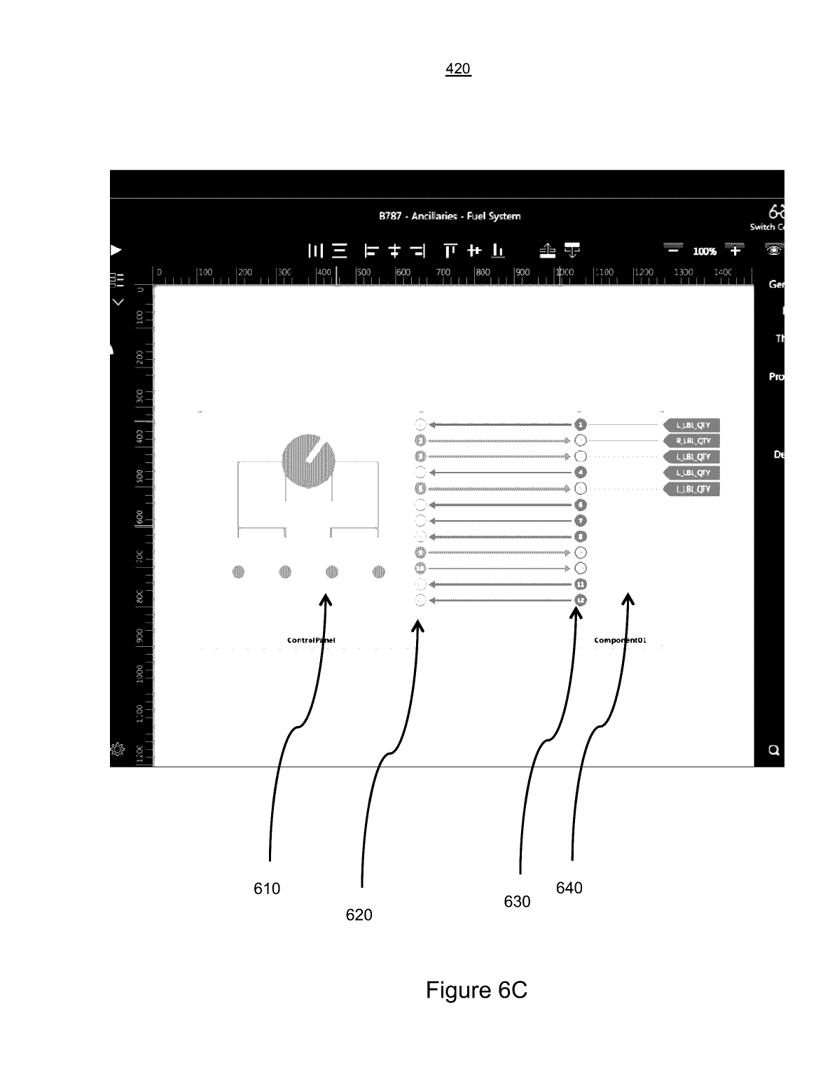

FIG. 6A represents a partial view of the section 410 of the GUI 400 now displaying a library of components consisting in a plurality of widgets (e.g. button, checkbox, textbox, etc.) for creating the simulation control pages or the simulation monitoring pages, as per step 215 of the method 200.

FIG. 6B represents a partial view of the section 420 of the GUI 400 now comprising a simulation control page being created using components selected from the library represented in FIG. 6A, as per steps 220 and 225 of the method 200.

FIG. 6C represents another partial view of the section 420 of the GUI 400 where interfaces 620 of components of a simulation control page 610 (for instance the components which have been created as illustrated in FIG. 6B) are interconnected with interfaces 630 of a component 640 of the simulator (e.g. the fuel tank 421 represented in FIG. 5B), for the purpose of controlling functionalities of the component 640, as per step 230 of the method 200.

Although the present disclosure has been described hereinabove by way of non-restrictive, illustrative embodiments thereof, these embodiments may be modified at will within the scope of the appended claims without departing from the spirit and nature of the present disclosure.

1. A customizable tool for the generation, validation and maintenance of simulation artefacts, the tool comprising:
a display;
memory for storing simulation artefacts;
a user interface for:
selecting a template corresponding to a particular type of simulation artefacts among a plurality of templates;
selecting at least one component among a library of components corresponding to the selected template; and
configuring the at least one selected component;
a processing unit for:
displaying the plurality of templates on the display;
determining the library of components corresponding to the selected template;
displaying the library of components on the display;
displaying the at least one selected component on the display;
generating the simulation artefacts corresponding to the selected template based on the at least one selected component and the configuration of each selected component, the generated simulation artefacts providing for operating a simulator;
validating the generated simulation artefacts, the validation comprising automatically detecting conflicts between the generated simulation artefacts and between the generated simulation artefacts and simulation artefacts stored in the memory, the detected conflicts comprising the configuration parameter of the selected and configured component of the generated simulation artefact being incompatible with at least one of the following:
the configuration parameter of the selected and configured component of another generated simulation artefact, and
the configuration parameter of the component of one of the simulation artefact stored in the memory; and
storing the validated simulation artefacts in the memory; and
a communication interface for transmitting the simulation artefacts to the simulator.

2. The customizable tool of claim 1, wherein the particular type of simulation artefacts consists in one of the following: artefacts for simulation models, artefacts for simulation control pages, and artefacts for simulation monitoring pages.

3. The customizable tool of claim 1, wherein the at least one selected component comprises at least one of the following characteristics: one or more configurable parameters, and one or more configurable interfaces.

4. The customizable tool of claim 3, wherein configuring the at least one selected component comprises one of the following: configuring at least one of the configurable parameters, and configuring at least one of the configurable interfaces.

5. The customizable tool of claim 4, wherein the at least one selected component consists in the one or more configurable interfaces and configuring at least one of the configurable interfaces comprises:
selecting the configured interface among the one or more configurable interfaces; and
selecting for connection with the configured interface a corresponding interface of a corresponding component among a list of interfaces of components compatible with the configured interface, the list being determined by the processing unit based on at least one characteristic of the configured interface, the list being displayed by the processing unit on the display for selection of the corresponding interface of the corresponding component via the user interface.

6. (canceled)

7. The customizable tool of claim 1, wherein at least one characteristic of a component of the library of components is updated via one of the user interface and the communication interface, and the validating depends on the at least one updated characteristic.

8. The customizable tool of claim 1, wherein the library of components comprises a hierarchy of components and sub-components, and the display of the library of components is representative of the hierarchy.

9. The customizable tool of claim 1, wherein the library of components is received via the communication interface from a computing device.

10. A method for generating and maintaining simulation artefacts, the method comprising:
selecting a template corresponding to a particular type of simulation artefacts among a plurality of templates;
determining a library of components corresponding to the selected template;
displaying the library of components on a display;
selecting at least one component among the library of components;
displaying the at least one selected component on the display;
configuring the at least one selected component;
generating by a processing unit simulation artefacts corresponding to the selected template based on the at least one selected component and the configuration of each selected component, the generated simulation artefacts providing for operating a simulator;
validating by the processing unit the generated simulation artefacts, the validation comprising automatically detecting conflicts between the generated simulation artefacts and between the generated simulation artefacts and simulation artefacts stored in memory, the detected conflicts comprising the configuration parameter of the selected and configured component of the generated simulation artefact being incompatible with at least one of the following:
the configuration parameter of the selected and configured component of another generated simulation artefact, and
the configuration parameter of the component of at least one of the simulation artefacts stored in the memory; and
storing the validated simulation artefacts in the memory.

11. The method of claim 10, wherein the particular type of simulation artefacts consists in one of the following: artefacts for simulation models, artefacts for simulation control pages, and artefacts for simulation monitoring pages.

12. The method of claim 10, further comprising transmitting the generated simulation artefacts to the simulator.

13. The method of claim 10, wherein the at least one selected component comprises at least one of the following characteristics: one or more configurable parameters, and one or more configurable interfaces.

14. The method of claim 13, wherein configuring the at least one selected component comprises one of the following: configuring at least one of the configurable parameters, and configuring at least one of the configurable interfaces.

15. The method of claim 14, wherein the at least one selected component consists in the one or more configurable interfaces and configuring at least one of the configurable interfaces comprises:
selecting a configured interface among the one or more configurable interfaces; and
selecting for connection with the configured interface a corresponding interface of a corresponding component among a list of interfaces of components compatible with the configured interface, the list being determined by the processing unit based on at least one characteristic of the configured interface.

16. (canceled)

17. The method of claim 10, wherein configuring the at least one selected component comprises updating at least one characteristic of the selected component, and the validation depends on the at least one updated characteristic.

18. The method of claim 10, wherein the library of components comprises a hierarchy of components and sub-components, and the display of the library of components is representative of the hierarchy.

19. The method of claim 10, wherein:
a plurality of libraries of components corresponding to the selected template are determined;
the plurality of libraries of components are displayed on the display; and
the at least one component is selected among the plurality of libraries of components.

20. A non-transitory electronically readable storage medium storing instructions, the instructions when executed by a processing unit providing for generating and maintaining simulation artefacts by:
selecting a template corresponding to a particular type of simulation artefacts among a plurality of templates;
determining a library of components corresponding to the selected template;
displaying the library of components on a display;
selecting at least one component among the library of components;
displaying the at least one selected component on the display;
configuring the at least one selected component;
generating simulation artefacts corresponding to the selected template based on the at least one selected component and the configuration of each selected component, the generated simulation artefacts providing for operating a simulator;
validating the generated simulation artefacts, the validation comprising automatically detecting conflicts between the generated simulation artefacts and between the generated simulation artefacts and simulation artefacts stored in the memory, the detected conflicts comprising the configuration parameter of the selected and configured component of the generated simulation artefact being incompatible with at least one of the following:
the configuration parameter of the selected and configured component of another generated simulation artefact, and
the configuration parameter of the component of one of the simulation artefacts stored in the memory; and
storing the validated simulation artefacts in the memory.
